(19) United States
(12) Patent Application Publication
(10) Pub. No.: US 2011/0290398 A1
(43) Pub. Date: Dec. 1, 2011

(54) PNEUMATIC TIRE FOR PASSENGER CAR AND METHOD OF MANUFACTURING THE SAME

(75) Inventor: Kaoru Yasuda, Kanagawa (JP)

(73) Assignee: THE YOKOHAMA RUBBER CO., LTD., Minato-ku, Tokyo (JP)

(21) Appl. No.: 13/147,764

(22) PCT Filed: Feb. 2, 2010
(86) PCT No.: PCT/JP2010/000599

§ 371 Date: Aug. 3, 2011

(30) Foreign Application Priority Data
Feb. 3, 2009 (JP) 2009-022125

(51) Int. Cl. B60C 9/28

(52) U.S. Cl. 152/527; 156/110.1

(57) ABSTRACT

A pneumatic tire for a passenger car includes a belt layer and a belt cover layer formed by winding a steel cord member in the tire circumference direction on the outer peripheral side of the belt layer. The steel cord member has a structure in which element wires made of steel and having a diameter smaller than 0.18 mm are twisted together to form each strand and the strands are twisted together in the same direction as the direction of twisting of the element wires. The twist pitch on each of the strands is smaller than the twist pitch on the steel cord member, the twist pitch on the strand is 1.0 mm to 2.1 mm, and the twist pitch on the steel cord member is 2.0 mm to 5.25 mm.

### TECHNICAL FIELD

The present invention relates to a pneumatic tire for a passenger car having a belt cover layer and a method of manufacturing the pneumatic tire for the passenger car.

### BACKGROUND ART

A pneumatic tire for a passenger car may be provided with a belt cover layer formed by winding a reinforcing cord in the tire circumference direction on the outer peripheral side of a belt layer in some cases. This belt cover layer has the following advantages. The belt cover layer suppresses rising of the belt layer toward the outer peripheral side during traveling at a high speed to suppress edge separation of the belt layer, i.e., to increase high-speed durability of the tire. Furthermore, the belt cover layer improves road noise (noise in a vehicle) performance by suppressing tire vibration.

Conventionally, as a reinforcing cord of the belt cover layer of the pneumatic tire, use of a steel cord member formed into wave shapes, for example, is known (see Patent Document 1, for example). When expansion (lift) of a circumferential length of a green tire to be vulcanized is carried out in vulcanization, the formed steel cord member elongates and the belt cover layer follows the lift. In this way, it is possible to avoid occurrence of vulcanization failure due to the belt cover layer while greatly improving high-speed durability and road noise performance due to a tightening effect (restraining effect) by tensile rigidity of the steel cord member which has fully elongated after the expansion (lift).

To obtain the above effect, however, it is necessary to use steel cord members to which different elongation characteristics are imparted by forming at different forming ratios, which indicate degrees of forming, according to tire specifications having different expansion ratios (lift ratios). Therefore, it is necessary to prepare various formed steel cords having different elongation characteristics according to different tire specifications. In other words, improvement of the high-speed durability and the road noise and suppression of the vulcanization failure cannot be realized at the same time without using a steel cord member having a forming ratio suitable to a tire specification having a given expansion ratio.

### CITATION LIST

### Patent Document

Patent Document 1: Japanese Patent Application Laid-Open No. 11-198605

### DISCLOSURE OF THE INVENTION

### Problems to be Solved by the Invention

It is an object of the present invention to provide a pneumatic tire for a passenger car and a method of manufacturing the pneumatic tire for the passenger car in which high-speed durability and road noise performance can be improved greatly and a vulcanization failure due to a belt cover layer can be suppressed to the same degree as that of a tire using the formed steel cord member by a different method from that of the above-described pneumatic tire for the passenger car using the formed steel cord member.

### Means for Solving the Problems

An aspect of the present invention is a pneumatic tire for a passenger car. The pneumatic tire comprising:

a belt layer and

a belt cover layer formed by winding a steel cord member in a tire circumference direction on an outer peripheral side of the belt layer, wherein

the steel cord member has a structure in which a plurality of element wires made of steel and having a diameter smaller than 0.18 mm are twisted together to form each of strands and the strands are twisted together in a same direction as a direction of twisting of the element wires, and

a twist pitch on each of the strands is smaller than a twist pitch on the steel cord member, the twist pitch on each of the strands is in a range of 1.0 mm to 2.1 mm, and the twist pitch on the steel cord member is in a range of 2.0 mm to 5.25 mm.

Another aspect of the present invention is a method of manufacturing a pneumatic tire for a passenger car. The method comprising the steps of

producing a green tire by forming a belt cover layer by winding a steel cord member covered with unvulcanized rubber in a tire circumference direction on an outer peripheral side of a belt layer and

vulcanizing the green tire while expanding a circumferential length of the green tire having the belt cover layer, and wherein

the steel cord member has a structure in which a plurality of element wires made of steel and having a diameter smaller than 0.18 mm are twisted together to form each of strands and the strands are twisted together in a same direction as a direction of twisting of the element wires, and

a twist pitch on each of the strands is smaller than a twist pitch on the steel cord member, the twist pitch on each of the strands is in a range of 1.0 mm to 2.0 mm, and the twist pitch on the steel cord member is in a range of 2.0 mm to 5.0 mm.

### Advantages of the Invention

With the pneumatic tire for the passenger car and the method of manufacturing the pneumatic tire for the passenger car according to the above-described aspects, the high-speed durability and the road noise performance can be improved greatly and the vulcanization failure due to the belt cover layer can be suppressed to the same degree as that of the tire using the formed steel cord member.

Moreover, the steel cord member elongates in the lift and the belt cover layer can follow the lift in the tire specifications having different expansion ratios (lift ratios). Therefore, in the pneumatic tire for the passenger car according to the above aspects, the high-speed durability and the road noise performance can be improved greatly and the vulcanization failure due to the belt cover layer can be suppressed even if the same steel cord member is used for the different tire specifications.

### BRIEF DESCRIPTION OF THE DRAWINGS

FIG. 1 is a partial sectional view illustrating an example of a pneumatic tire for a passenger car according to the present invention.

FIG. 2 is an enlarged sectional view of a steel cord member covered with rubber.

FIG. 3 is an explanatory view illustrating a step of forming a first formed body.

FIG. 4 is an explanatory view illustrating a step of forming a belt cover layer.

FIG. 5 is an enlarged sectional view of an example of a steel cord.

FIG. 6 is a graph illustrating an example of a load-elongation curve of the steel cord.

FIG. 7 is an explanatory view illustrating a step of forming a second formed body by bonding a tread rubber layer.

FIG. 8 is an explanatory view illustrating a step of forming an unvulcanized tire by pressure-bonding the first formed body to the second formed body.

### MODE FOR CARRYING OUT THE INVENTION

Embodiments of the present invention will be described below in detail with reference to the accompanying drawings.

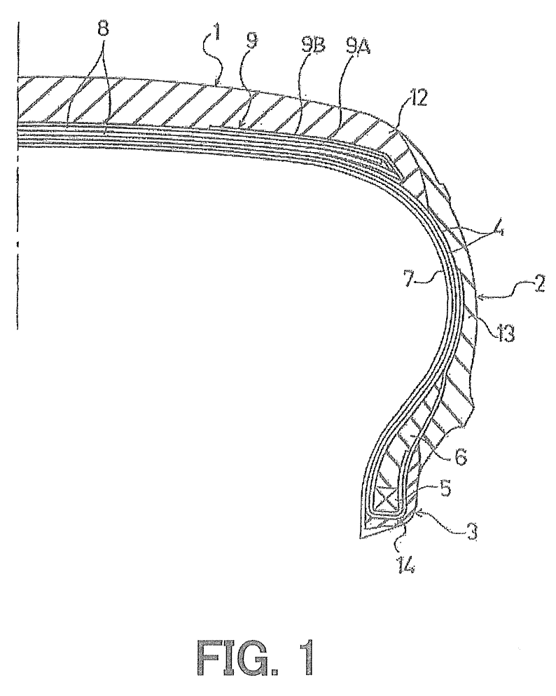

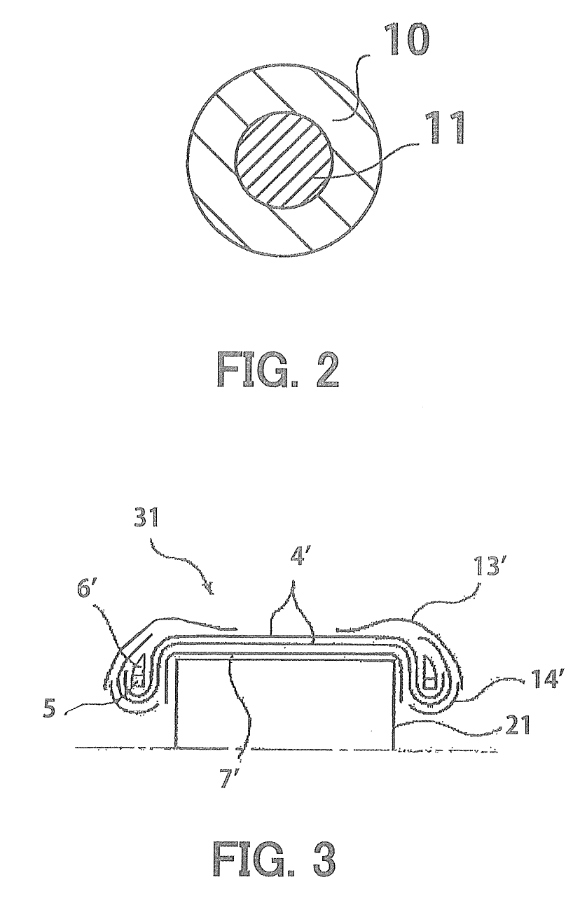

FIG. 1 is a drawing illustrating an example of a pneumatic tire for a passenger car according to the invention. The pneumatic tire for the passenger car (hereafter referred to as “tire”) illustrated in FIG. 1 mainly includes a tread portion 1, side wall portions 2, bead portions 3, two carcass layers 4, bead cores 5, bead fillers 6, an inner liner layer 7, belt layers 8, and a belt cover layer 9. The tire “for the passenger car” is a tire defined in Chapter A of JATMA YEAR BOOK 2009, a tire defined in SECTION 1 of TRA, or a tire defined in General notes “Passenger car tires” of ETRTO.

The two carcass layers 4 of the tire illustrated in FIG. 1 are formed by arranging reinforcing cords extending in a tire radial direction at predetermined intervals in the tire circumference direction. The reinforcing cords are embedded in a rubber layer and extending between the left and right bead portions 3. Each of opposite end portions of the two carcass layers 4 is folded back from an inside to an outside in a tire axial direction so as to wrap the bead filler 6 around the bead core 5 embedded in the bead portion 3.

The inner liner layer 7 is formed on an inner side of the carcass layers 4. The two belt layers 8 are formed on the outer peripheral side of the carcass layers 4 in the tread portion 1. The two belt layers 8 are formed by arranging reinforcing cords extending while inclined in the tire circumference direction at predetermined intervals in the tire circumference direction. The reinforcing cords are embedded in rubber layers. Inclined directions of the reinforcing cords of the two belt layers 8 with respect to the tire circumference direction are placed opposite to and intersecting each other.

The belt cover layer 9 is formed on the outer peripheral side of the belt layers 8. The belt cover layer 9 includes one layer of a belt full cover layer 9A and one layer of belt edge cover layers 9B. The belt full cover layer 9A covers the entire belt layers 8 and the belt edge cover layers 9B cover the end portions of the belt layers 8. The belt full cover layer 9A and the belt edge cover layers 9B of the belt cover layer 9 are formed by helically winding a single steel cord member 11 covered with rubber 10 in the tire circumference direction.

The steel cord member 11 has a structure in which a plurality of element wires made of steel and having a diameter smaller than 0.18 mm and preferably of 0.08 to 0.15 mm are twisted together to form each strand and the plurality of strands are twisted together in the same direction as the direction of twisting of the element wires (see FIG. 5).

Furthermore, a twist pitch on each of the strands is smaller than a twist pitch on the steel cord member 11. The twist pitch on the strand is 1.0 mm to 2.1 mm and the twist pitch on the steel cord member 11 is 2.0 mm to 5.25 mm. These twist pitches are values in the tire which has been subjected to the lift. In the present embodiment, an upper limit of the twist pitch on the strand and an upper limit of the twist pitch on the steel cord member 11 are 2.1 mm and 5.25 mm, respectively. These values are the twist pitches in the lifted tire after the vulcanization. Upper limits of the twist pitches in the not-lifted tire before the vulcanization are 2.0 mm and 5.0 mm, respectively, as described later. If an expansion ratio (lift ratio) of a green tire during the vulcanization is α, the twist pitches are 2.0×(1+α/100) and 5.0×(1+α/100). An upper limit of the expansion ratio (lift ratio) is about 5% and therefore upper limits of the twist pitches in the lifted tire after the vulcanization are 2.1 mm (=2.0×1.05) and 5.25 mm (5.0×1.05), respectively.

In the embodiment, a lower limit of the twist pitch on the strand and a lower limit of the twist pitch on the steel cord member 11 are 1.0 mm (after the vulcanization) and 2.0 mm (after the vulcanization), respectively. Lower limits of the twist pitches in the not-lifted tire before the vulcanization are 1.0 mm and 2.0 mm, respectively. The reason why the lower limits before and after the vulcanization are the same is that the expansion ratio is extremely low in some cases.

A tread rubber layer 12 is provided on the outer peripheral side of the belt cover layer 9. A side rubber layer 13 is provided on an outer side of the carcass layers 4 in each of the side wall portions 2. A rim cushion rubber layer 14 is provided on an outer side of the folded-back portion of the carcass layers 4 in each of the bead portions 3.

As described above, in the embodiment, the twist pitch on each of the strands is set to be smaller than the twist pitch on the steel cord member 11, the twist pitch on the strand is set to 1.0 mm to 2.1 mm and the twist pitch on the steel cord member 11 is set to 2.0 mm to 5.25 mm. As a result, the belt cover layer becomes more easily to follow the expansion (lift) of the circumferential length of the green tire during the vulcanization and it is possible to effectively exert the tightening effect (restraining effect) due to the tensile rigidity of the steel cord member after the expansion.

The steel cord member 11 in the belt cover layer 9 after the vulcanization is covered with rubber and voids in the steel cord member 11, e.g., voids between the strands and voids between the element wires are filled with rubber.

If tensile rigidity of the steel cord member 11 taken out of the belt cover layer 9 after the vulcanization is H_{c}′ and tensile rigidity of the steel cord member 11 when a portion of the rubber covering the steel cord member 11 after the vulcanization and a portion of the rubber filling the voids in the steel cord member 11 are removed is H_{b}′, a ratio H_{c}′/H_{b}′ is preferably 1.6 to 2.4. The rubber covering the steel cord member is removed from the belt cover layer 9 after the vulcanization by pulling the steel cord member out of the belt cover layer 9, for example. To remove the rubber filled into the voids as well as to remove the rubber covering the steel cord member from the belt cover layer 9 after the vulcanization, the pulled-out steel wire material is immersed in an organic solvent. In this way, it is possible to dissolve the rubber covering the steel cord member and filled in the voids. As a result, it is possible to obtain the steel cord member from which the rubber covering it and filled in the voids is removed.

The ratio H_{c}′/H_{b}′ of the tensile rigidities is substantially the same as a ratio H_{c}/H_{b} which will be described later. In other words, while the steel cord member after the vulcanization is elastically elongated by the rubber covering it, the steel cord member tries to return into a zero elongation state when the rubber covering it is removed. However, voids in the steel cord member after the vulcanization are filled with rubber. Therefore, the steel cord member after the vulcanization is not necessarily in the same state as before the vulcanization. By removing the rubber filled in the voids in the steel cord member, the steel cord member comes into the same state (the zero elongation state) as the state before the vulcanization. Therefore, the tensile rigidity of the steel cord member taken out of the belt cover layer 9 after the vulcanization corresponds to H_{c} which will be described later and the tensile rigidity of the steel cord member in the belt cover layer 9 after the vulcanization from which the rubber covering the steel cord member and the rubber filling the voids are removed corresponds to H_{b} which will be described later. The tensile rigidity of the steel cord member taken out of the belt cover layer 9 after the vulcanization and the tensile rigidity of the steel cord member from which the rubber covering the steel cord member in the belt cover layer 9 after the vulcanization is removed and the rubber filling the voids is removed are measured by the same methods as those for the tensile rigidities H_{b} and H_{c} which will be described later.

Because the ratio H_{c}′/H_{b}′ of the tensile rigidities is 1.6 to 2.4, the belt cover layer 9 can more reliably follow the lift during the vulcanization and more effectively exert the tightening effect (restraining effect) of the belt cover layer 9.

With reference to FIGS. 3 to 8, a method of manufacturing the pneumatic tire for the passenger car illustrated in FIG. 1 by the manufacturing method according to the invention will be described.

First, as illustrated in FIG. 3, similarly to a prior-art method, by bonding (attaching) an unvulcanized inner liner layer 7′, unvulcanized carcass layers 4′, the bead cores 5 to which unvulcanized bead fillers 6′ are attached, unvulcanized rim cushion rubber layers 14′, and unvulcanized side rubber layers 13′ in order on a first forming drum 21, a first formed body 31 is formed.

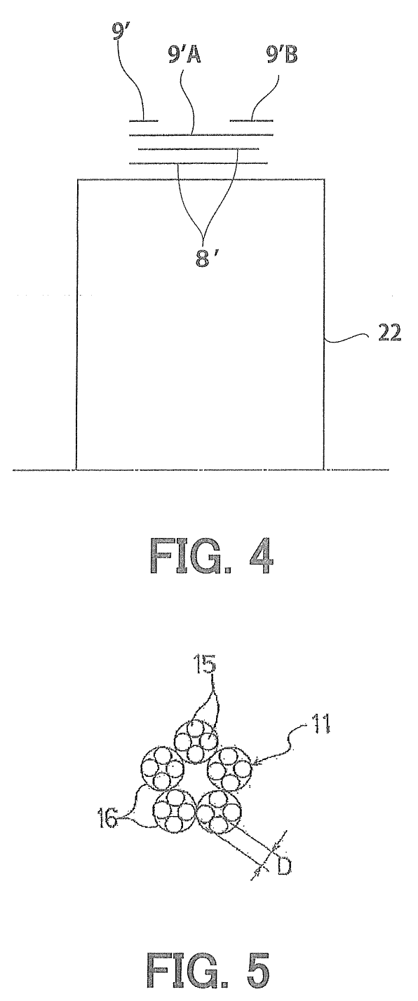

On the other hand, as illustrated in FIG. 4, similarly to the prior-art method, unvulcanized belt layers 8′ are bonded onto a second forming drum 22. Then, the single steel cord member 11 covered with unvulcanized rubber is helically wound at an angle close to 0° (not greater than 5°) in the tire circumference direction (drum circumference direction) around the belt layers 8′ to form the belt full cover layer 9′A and the belt edge cover layers 9′B.

The steel cord member 11 used to form the unvulcanized belt cover layer 9′ has an N×M double twist structure in which the M element wires 15 are twisted together to form each strand 16 and the N strands 16 are twisted together in the same direction as the direction of twisting of the element wires 15 as illustrated in FIG. 5. In the example illustrated in FIG. 5, it is the 5×4 double twist structure in which M is 4 and N is 5. As described later, it is preferable that M=4 and N=4 or 5.

The steel cord member 11 used to form the belt full cover layer 9′A and belt edge cover layers 9′B before subjected to the lift will be described in detail.

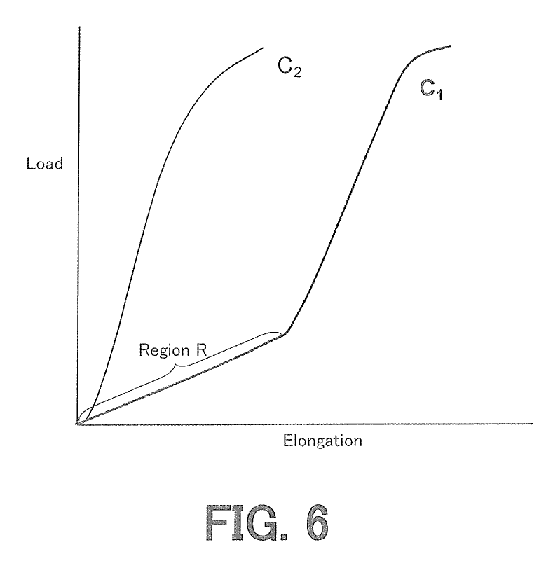

In the steel cord member 11, the twist pitch on the strand 16 formed by twisting the element wires 15 together is smaller than the twist pitch on the steel cord member 11 formed by twisting the strands 16. The twist pitch on the strand 16 is set in a range of 1.0 mm to 2.0 mm and the twist pitch on the steel cord member 11 is set in a range of 2.0 mm to 5.0 mm. The steel cord member 11 formed in this manner has such a characteristic that a load-elongation curve has an inflection point where a slope of the curve C₁ changes sharply as illustrated in FIG. 6.

Here, in the lift for expanding the circumferential length of the tire in the vulcanization of the tire, elongation of the steel cord member 11 is carried out in a region R in FIG. 6 where the elongation is lower than that at the inflection point.

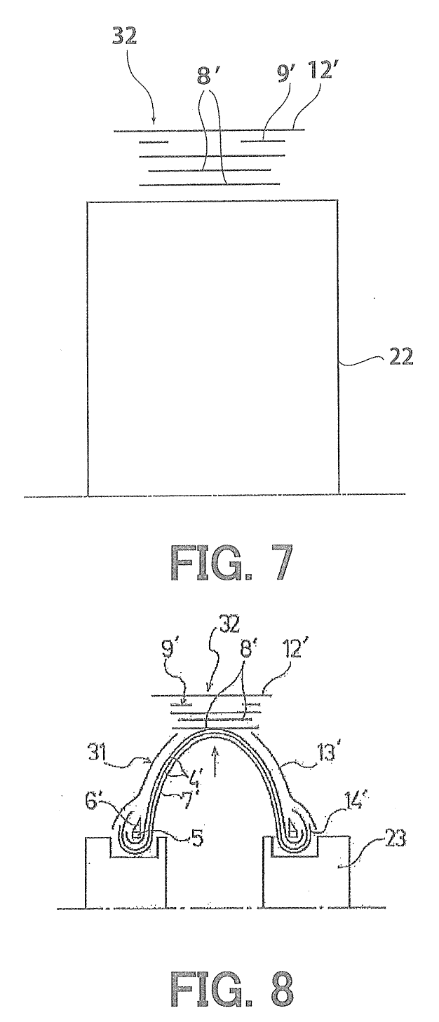

After the belt cover layer 9′ is formed, as illustrated in FIG. 7, an unvulcanized tread rubber layer 12′ is bonded on the outer peripheral side of the belt cover layer 9′ to form a second formed body 32.

By detaching the first formed body 31 and the second formed body 32 respectively from the forming drums 21 and 22, setting the first formed body 31 and the second formed body 32 on a shaping drum 23 as illustrated in FIG. 8, and then applying the internal pressure by using a bladder (not illustrated), the first formed body 31 is inflated into a toroidal shape and press-fitted on an inner peripheral side of the second formed body 32 disposed on the outer peripheral side. As a result, an unvulcanized tire is formed. This unvulcanized tire (green tire) is expanded (lifted) in a mold of a tire vulcanizing machine, i.e., the vulcanization is carried out while expanding the tire circumferential length. In this way, the pneumatic tire for the passenger car illustrated in FIG. 1 is obtained.

According to the above-described embodiment, the steel cord member 11 in the belt cover layer 9′ has the double twist structure in which the element wires 15 and the strands 16 are twisted in the same direction, the twist pitch on the strand 16 is set to be 2.0 mm or smaller, and the twist pitch on the steel cord member 11 is set to be 5.0 mm or smaller. In this way, the steel cord member 11 sufficiently elongates and the belt cover layer 9′ can follow the lift when the lift is applied to the unvulcanized tire in the mold during the vulcanization. As a result, it is possible to avoid occurrence of the vulcanization failure due to the belt cover layer. As is clear from examples described later, the steel cord member 11 can elongate to follow the lift in tire specifications having different lift ratios and therefore it is possible to use the same steel cord member 11 for the tire specifications having the different lift ratios.

On the other hand, by setting the twist pitch on the strand 16 to be 1.0 mm or greater and setting the twist pitch on the steel cord member 11 to 2.0 mm or greater, the steel cord member 11 does not elongate excessively. Furthermore, because the vulcanized rubber 10 covers a periphery of the steel cord member 11 or the vulcanized rubber 10 is filled in the voids between the strands 16 and between the element wires 15 of the steel cord member 11 after the vulcanization, the elongation of the steel cord member 11 is suppressed and the steel cord member 11 becomes less liable to elongate. In other words, rigidity of the steel cord member 11 increases. With this rigidity of the steel cord member 11, it is possible to greatly improve the high-speed durability and the road noise performance to the same degree as that of the prior-art belt cover layer formed in the wave shapes.

If the twist pitch on the strand 16 is over 2.0 mm, the steel cord member 11 may become less liable to elongate in the lift in some cases in which the tire specifications have the different lift ratios (expansion ratios), e.g., a high lift ratio. This holds true in a case in which the twist pitch on the steel cord member 11 is over 5.0 mm.

If the twist pitch on the strand 16 is smaller than 1.0 mm, the steel cord member 11 elongates excessively. As a result, the vulcanized rubber covering the periphery of the steel cord member 11 cannot suppress the elongation and it is impossible to obtain the effect of greatly improving the high-speed durability and the road noise performance. This holds true in a case in which the twist pitch on the steel cord member 11 is smaller than 2.0 mm.

In the invention, the number M of the element wires 15 to be twisted together is preferably 4 from a viewpoint of stability of a cord structure. The number N of the strands 16 to be twisted together is preferably 4 or 5. If the number N is 3 or smaller, it is impossible to twist the strands 16 at the above-described small pitch. If the number N is 6 or greater, on the other hand, it is difficult to retain a cord shape.

The diameter D of the element wire 15 is smaller than 0.18 mm and is preferably in a range of 0.08 mm to 0.15 mm. If the diameter D of the element wire 15 is 0.08 mm or greater, rigidity of the belt cover layer 9 is secured and the high-speed durability increases. On the other hand, if the diameter D of the element wire 15 is smaller than 0.15 mm, surface distortion at bent portions of the steel cord member 11 can be suppressed and therefore bending fatigue resistance increases.

If the tensile rigidity of the steel cord member 11 in the zero elongation state before the steel cord member 11 is covered with the unvulcanized rubber is H_{b} and the tensile rigidity of the steel cord member 11 of the belt cover layer 9 in the expanded and elongated state due to the lift in the tire vulcanization is H_{c}, the ratio H_{c}/H_{b} between the tensile rigidity H_{c} and the tensile rigidity H_{b} is preferably in a range of 1.6 to 2.4. The ratio H_{c}/H_{b} is a parameter representing a ratio between a degree of biting of the steel cord member 11 into the belt layer because the steel cord member 11 does not elongate to follow the lift at the time of the lift in the vulcanization and a degree of rigidity of the belt cover layer after the vulcanization. If the ratio H_{c}/H_{b} is over 2.4, the belt cover layer 9 becomes less liable to follow the lift in the vulcanization and becomes more liable to bite into the belt layer. If the ratio H_{c}/H_{b} is smaller than 1.6, the rigidity of the belt cover layer 9 is insufficient and the high-speed durability and the road noise performance do not increase. The ratio H_{c}/H_{b} in the above range can be achieved by setting the twist pitch on the strand and the twist pitch on the steel cord member 11 to the above-described ranges and properly combining the two twist pitches. A curve C₂ in FIG. 6 is a load-elongation curve of the steel cord member 11 after the vulcanization.

The tensile rigidity H_{b} of the steel cord member 11 is obtained as follows. One steel cord member 11 is cut to a length of 600 mm and set in a tensile testing machine by using respective 50-milimeter-long opposite end portions as grip margins (test length of 500 mm) and a load (N) and elongation (%) are recorded until the steel cord member 11 ruptures at a testing speed of 10 mm/minute. In the load-elongation curve obtained from the record, a slope of a straight line between the times when the load is 0 N and when the load is 200 N is evaluated as the tensile rigidity H_{b} of the steel cord member 11.

The tensile rigidity H_{c} of the steel cord member 11 of the belt cover layer 9 expanded and elongated by the lift in the tire vulcanization is obtained as follows. The single steel cord (600 mm in length) covered with rubber and taken out of the belt cover layer 9 of the vulcanized tire is set and the load (N) and elongation (%) are recorded similarly to the above. In a load-elongation curve obtained from the record obtained therefrom, a slope of a straight line between the times when the load is 0 N and when the load is 200 N is evaluated as the tensile rigidity H_{c}.

Although the pneumatic tire having the two layers, i.e., the belt full cover layer 9A covering the entire belt layers 8 and the belt edge cover layers 9B covering the end portions of the belt layers 8 as the belt cover layer 9 is illustrated in the example in FIG. 1 in the above embodiment, the pneumatic tire is not limited to it. The pneumatic tire for the passenger car manufactured by the method in the invention may have any belt cover layer.

Moreover, to form the belt cover layer 9′, it is preferable to use the single steel cord member 11 covered with the unvulcanized rubber as described above in order to minimize edges of the steel cord member 11 to enhance durability of the belt cover layer 9. However, a strip material formed by aligning a plurality of steel cord members 11 into a band shape having a certain width and covering them with unvulcanized rubber may be used.

The invention may be used especially suitably for a method of manufacturing a pneumatic tire for a passenger car having a belt cover layer.

### First Example

Ten pneumatic tires for a passenger car, each having the structure illustrated in FIG. 1, and of a tire size of 195/65R14 were manufactured for each of examples 1 to 18 and comparative examples 1 to 5. Ten pneumatic tires each having the structure illustrated in FIG. 1 were manufactured by using a steel cord member 11 having a 1×5 structure formed into a wave shape (having an element wire diameter of 0.15 mm formed according to the tire specification) for a belt cover layer (prior-art example 1). Furthermore, ten pneumatic tires each having the structure illustrated in FIG. 1 were manufactured by using an organic fiber belt cover layer made up of an organic fiber cord (nylon cord) instead of the steel cord member 11 as the belt cover layer 9 (prior-art example 2).

The steel cord member 11 used in each of the examples 1 to 18 and the comparative examples 1 to 5 had a 5×4 or 4×4 double twist structure in which four element wires (0.11 mm in diameter) were twisted together to form each strand and the five strands were twisted together in the same direction as the direction of twisting of the element wires. Twist pitches of the strands and the twist pitches of the steel cords were set as shown in Tables 1 to 4. The twist pitches of the strands and the twist pitches of the steel cords shown in Tables 1 to 4 are the twist pitches before the tires are subjected to the lift.

The lift ratio in vulcanization of the manufactured tires was 2.2%.

In the ten manufactured tires, the number of incidence of tires suffering from vulcanization failure (shape distortion) caused by the belt cover layer was studied visually and each number was evaluated in a four-level rating system (zero, one or two, three or four, and five or more tires). Evaluation results are shown in Tables 1 to 4.

The tires without the vulcanization failure were selected, respectively mounted to “standard rims”, filled with air pressure of 196 kPa, and subjected to evaluation tests for the high-speed durability and sound pressure of the road noise by the following test method. Evaluation results are shown in Tables 1 to 4.

Here, the “standard rim” refers to the “applicable rim” defined by JATMA, the “Design Rim” defined by TRA, or the “Measuring Rim” defined by ETRTO.

### High-Speed Durability

Each of the tires was mounted in a drum testing machine and was subjected to a high-speed durability test pursuant to the high-speed durability test described in JISD423. An evaluation result was obtained as an index when the high-speed durability of the tires in the example 3 was 100. The higher the index, the higher the high-speed durability is.

### Road Noise

Each of the tires was mounted to a vehicle of 3600 cc displacement and sensory evaluation of noise in the vehicle during traveling of the vehicle on a test course was carried out by a test driver. An evaluation result was obtained as an index when the noise in the vehicle with the tires in the example 3 was 100. The higher the index, the lower the sound pressure level of the road noise is and the more excellent the noise performance is.

TABLE 1

| | Example | Example | Example | Example | Example | Comparative | Comparative | Prior-art | Prior-art |
|---|---|---|---|---|---|---|---|---|---|
| | 1 | 2 | 3 | 4 | 5 | example 1 | example 2 | example 1 | example 2 |
| Cord structure | 5 × 4 | ← | ← | ← | ← | ← | ← | — | — |
| Twist pitch of | 1.0 | 1.2 | 1.5 | 1.8 | 2.0 | 0.8 | 2.2 | — | — |
| strand (mm) | | | | | | | | | |
| Twist pitch of steel | 3.5 | ← | ← | ← | ← | ← | ← | — | — |
| cord (mm) | | | | | | | | | |
| Ratio Hc/Hb | 1.5 | 1.7 | 2.0 | 2.3 | 2.4 | 1.4 | 2.6 | — | — |
| Vulcanization failure | zero | zero | zero | 1 or 2 | 3 or 4 | zero | 5 or more | zero | zero |
| High-speed | 90 | 100 | 100 | 100 | 100 | 80 | 100 | 80.0 | 80.0 |
| durability | | | (Reference) | | | | | | |
| Road noise | 90 | 100 | 100 | 100 | 100 | 80 | 100 | 80.0 | 80.0 |
| | | | (Reference) | | | | | | |

TABLE 2

| | | | | | Comparative | Comparative | |
|---|---|---|---|---|---|---|---|
| | Example 6 | Example 7 | Example 8 | Example 9 | example 1 | example 4 | Example 10 |
| Cord structure | 5 × 4 | ← | ← | ← | ← | ← | 4 × 4 |
| Twist pitch of | 1.5 | ← | ← | ← | ← | ← | ← |
| strand (mm) | | | | | | | |
| Twist pitch of steel | 2.0 | 2.2 | 4.8 | 5.0 | 1.8 | 5.2 | 3.5 |
| cord (mm) | | | | | | | |
| Ratio Hc/Hb | 1.5 | 1.7 | 2.3 | 2.4 | 1.4 | 2.6 | 2.1 |
| Vulcanization failure | zero | zero | 1 or 2 | 3 or 4 | zero | 5 or more | zero |
| High-speed | 90 | 100 | 100 | 100 | 80 | 100 | 100 |
| Road noise | 90 | 100 | 100 | 100 | 80 | 100 | 100 |

TABLE 3

| | | | | | | Comparative |
|---|---|---|---|---|---|---|
| | Example 11 | Example 7 | Example 12 | Example 13 | Example 14 | example 5 |
| Cord structure | 5 × 4 | ← | ← | ← | ← | ← |
| Twist pitch of | 1.5 | ← | ← | ← | ← | ← |
| strand (mm) | | | | | | |
| Twist pitch of steel | 3.5 | ← | ← | ← | ← | ← |
| cord (mm) | | | | | | |
| Diameter d of | 0.08 | 0.11 | 0.15 | 0.17 | 0.06 | 0.18 |
| element wire (mm) | | | | | | |
| Ratio Hc/Hb | 1.5 | 1.7 | 2.5 | 2.7 | 1.4 | — |
| Vulcanization failure | zero | zero | 1 or 2 | 3 or 4 | zero | — |
| High-speed | 90 | 100 | 100 | 100 | 80 | — |
| Road noise | 90 | 100 | 100 | 100 | 80 | — |

TABLE 4

| | Example 15 | Example 16 | Example 17 | Example 18 |
|---|---|---|---|---|
| Cord structure | 5 × 4 | ← | ← | ← |
| Twist pitch of | 1.2 | 1.3 | 1.9 | 2.0 |
| strand (mm) | | | | |
| Twist pitch of | 2.5 | 2.7 | 4.3 | 4.5 |
| steel cord (mm) | | | | |
| Ratio Hc/Hb | 1.3 | 1.6 | 2.4 | 2.6 |
| Vulcanization | zero | zero | 1 or 2 | 3 or 4 |
| failure | | | | |
| High-speed | 85 | 100 | 100 | 100 |
| Road noise | 85 | 100 | 100 | 100 |

As is clear from Tables 1 and 2, in the steel cord member 11 in each of the examples 1 to 10, the twist pitch on each strand is smaller than the twist pitch on the steel cord member 11 and is in the range of 1.0 mm to 2.0 mm (1.0 to 2.1 mm in a tire product) and the twist pitch on the steel cord member is in the range of 2.0 to 5.0 mm (2.0 mm to 5.25 mm in a tire product). By using the steel cord member 11 for the belt cover layer 9, it is possible to obtain similar performance to that of the tires in the prior-art example 1 in which the high-speed durability and the road noise performance are improved greatly without causing the vulcanization failure due to the belt cover layer.

In the prior-art example 1, the formed steel cord did not fully elongate in the lift and there was the slack in the formed steel cord in the tire after the vulcanization. As a result, the high-speed durability and the road noise performance reduced. In other words, the steel cord was not appropriate in the tire specifications of this tire and the steel cord having a different forming ratio was necessary.

Therefore, evaluations of the high-speed durability and the road noise of the prior-art example 1 were equivalent to those of the prior-art example 2 using the organic fiber belt cover layer made up of the organic fiber cord (nylon cord).

Table 3 shows effects of diameters of element wires used for the steel cord members 11. As is clear from the examples 7 and 11 to 14, the diameter d of the element wire is preferably smaller than 0.18 mm. If the diameter d of the element wire is 0.18 mm or greater, it is difficult to carry out the lift in the vulcanization, therefore, it is impossible to manufacture the tire.

From the viewpoints of the high-speed durability and the road noise, the diameter d of the element wire is preferably 0.08 mm to 0.15 mm.

Table 4 shows effects of the ratios H_{c}/H_{b} in the steel cord members 11.

As shown in Table 4, even if the twist pitch on the strand is in the range of 1.0 mm to 2.0 mm (1.0 to 2.1 mm in the tire product) and the twist pitch on the steel cord member is 2.0 to 5.0 mm (2.0 mm to 5.0 mm in the tire product), the ratio H_{c}/H_{b} is not necessarily 1.6 to 2.4. The ratio H_{c}/H_{b} is determined by a combination of the twist pitch on the strand and the twist pitch on the steel cord member. If the ratio H_{c}/H_{b} is 1.6 to 2.4, it is possible to produce the tire without problem (with little vulcanization failure) and the high-speed durability and the road noise improve as compared with the prior-art examples 1 and 2. In this respect, the ratio H_{c}/H_{b} is preferably 1.6 to 2.4.

### Second Example

Ten pneumatic tires for a passenger car, each having the structure illustrated in FIG. 1, and of a tire size of 245/40R20 were manufactured for each of examples 19 to 28 and comparative examples 6 to 9. Ten pneumatic tires each having the structure illustrated in FIG. 1 were manufactured by using a steel cord member 11 having a 1×5 structure formed into a wave shape (having an element wire diameter of 0.15 mm formed according to the tire specification) for a belt cover layer (prior-art example 3). Furthermore, ten pneumatic tires each having the structure illustrated in FIG. 1 were manufactured by using an organic fiber belt cover layer made up of an organic fiber cord (nylon cord) instead of the steel cord member 11 as the belt cover layer 9 (prior-art example 4).

The steel cord member 11 used in each of the examples 19 to 28 and the comparative examples 6 to 9 had a 5×4 or 4×4 double twist structure in which four element wires (0.11 mm in diameter) were twisted together to form each strand and the five strands were twisted together in the same direction as the direction of twisting of the element wires. Twist pitches of the strands and the twist pitches of the steel cords were set as shown in Tables 1 to 4.

The lift ratio in vulcanization of the manufactured tires was 3.6%.

In the ten manufactured tires, the number of incidence of tires suffering from vulcanization failure (shape distortion) was studied similarly to the first example and each number was evaluated in the same four-level rating system as the above. Evaluation results are shown in Tables 5 and 6.

The tires without the vulcanization failure were selected, respectively mounted to “standard rims”, filled with air pressure of 196 kPa, and subjected to evaluation tests for the high-speed durability and the road noise by the test method shown in the first example. Evaluation results are shown in Tables 5 and 6.

TABLE 5

| | Example | Example | Example | Example | Example | Comparative | Comparative | Prior-art | Prior-art |
|---|---|---|---|---|---|---|---|---|---|
| | 19 | 20 | 21 | 22 | 23 | example 6 | example 7 | example 3 | example 4 |
| Cord structure | 5 × 4 | ← | ← | ← | ← | ← | ← | — | — |
| Twist pitch of | 1.0 | 1.2 | 1.5 | 1.8 | 2.0 | 0.8 | 2.2 | — | — |
| strand (mm) | | | | | | | | | |
| Twist pitch of steel | 3.5 | ← | ← | ← | ← | ← | ← | — | — |
| cord (mm) | | | | | | | | | |
| Ratio Hc/Hb | 1.6 | 1.7 | 2.0 | 2.3 | 2.5 | 1.4 | 2.6 | — | — |
| Vulcanization failure | zero | zero | zero | 1 or 2 | 3 or 4 | zero | 5 or more | zero | zero |
| High-speed | 95 | 100 | 100 | 100 | 100 | 80 | 100 | 100.0 | 80.0 |
| Road noise | 95 | 100 | 100 | 100 | 100 | 80 | 100 | 100.0 | 80.0 |

TABLE 6

| | | | | | Comparative | Comparative | |
|---|---|---|---|---|---|---|---|
| | Example 24 | Example 25 | Example 26 | Example 27 | example 8 | example 9 | Example 28 |
| Cord structure | 5 × 4 | ← | ← | ← | ← | ← | 4 × 4 |
| Twist pitch of | 1.5 | ← | ← | ← | ← | ← | ← |
| strand (mm) | | | | | | | |
| Twist pitch of steel | 2.0 | 2.2 | 4.8 | 5.0 | 1.8 | 5.2 | 3.5 |
| cord (mm) | | | | | | | |
| Ratio Hc/Hb | 1.6 | 1.7 | 2.3 | 2.5 | 1.4 | 2.6 | 2.1 |
| Vulcanization failure | zero | zero | 1 or 2 | 3 or 4 | zero | 5 or more | zero |
| High-speed | 95 | 100 | 100 | 100 | 80 | 100 | 100 |
| Road noise | 95 | 100 | 100 | 100 | 80 | 100 | 100 |

The lift ratio in the vulcanization of the tires in the second example was higher than that in the first example. Therefore, from Tables 5 and 6, the vulcanization failure due to the belt cover layers did not occur and the high-speed durability and the road noise performance were improved greatly not only in the tires of the examples 19 to 28 but also in the tires of the example 3. Evaluations of the high-speed durability and the road noise of the prior-art example 4 were low in spite of the high lift ratio. This is because by using the organic fiber belt cover layer, the tightening effect of the tensile rigidity of the belt cover layer was not sufficiently exerted.

Therefore, in each of the examples 19 to 28, similarly to the prior-art example 3, the high-speed durability and the road noise performance were greatly improved without causing the vulcanization failure due to the belt cover layer.

As described above, the steel cord member 11 is more excellent than the prior-art formed steel cord as the belt cover layer 9 in that the same steel cord member can be used for the tire specifications having the different lift ratios.

As described above, even if the lift ratio of the steel cord member 11 is different, the tightening effect of the tensile rigidity of the belt cover layer is maintained, because when the steel cord member 11 elongates in the vulcanization, the rubber is filled into the voids in the steel cord member 11 to restrain movements of the strands and the element wires, which increases the tensile rigidity of the steel cord member 11.

The tensile rigidity of the steel cord of each of the tires of the prior-art example 1 in the first example is determined by whether or not the formed shape remains after the formed shape elongates. Therefore, in the first example with the low lift ratio, the formed steel cord did not fully elongate and the slack remained in the formed steel cord in the tire after the vulcanization and therefore the evaluations of the high-speed durability and the road noise performance were low. In other words, different formed steel cords are necessary for tire specifications having different lift ratios.

As described above, in the tire in the present embodiment, by using the steel cord member 11 for the belt cover layer 9, the high-speed durability and the road noise performance can be improved greatly to the same degree as the tire using the formed steel cord member and the vulcanization failure due to the belt cover layer can be suppressed.

Moreover, the steel cord member 11 elongates in the lift and the belt cover layer 9 can follow the lift in the tire specifications having different expansion ratios (lift ratios). Therefore, in the tire of the present embodiment, the high-speed durability and the road noise performance can be improved greatly and the vulcanization failure due to the belt cover layer can be suppressed even if the same steel cord member is used for the different tire specifications.

### DESCRIPTION OF SYMBOLS

8, 8′ belt layer
9, 9′ belt cover layer
11 steel cord member
15 element wire
16 strand
D diameter

1. A pneumatic tire for a passenger car comprising:
a belt layer; and
a belt cover layer formed by winding a steel cord member in a tire circumference direction on an outer peripheral side of the belt layer, wherein
the steel cord member has a structure in which a plurality of element wires made of steel and having a diameter smaller than 0.18 mm are twisted together to form each of strands and the strands are twisted together in a same direction as a direction of twisting of the element wires, and
a twist pitch on each of the strands is smaller than a twist pitch on the steel cord member, the twist pitch on each of the strands is in a range of 1.0 mm to 2.1 mm, and the twist pitch on the steel cord member is in a range of 2.0 mm to 5.25 mm.

2. The pneumatic tire for a passenger car according to claim 1, wherein
the steel cord member is covered with rubber and a void in the steel cord member is filled with the rubber; and
a ratio is 1.6 to 2.4, wherein the ratio is a ratio of tensile rigidity of the steel cord member taken out of the belt cover layer to tensile rigidity of the steel cord member when a portion of the rubber covering the steel cord member and a portion of the rubber filling the void are removed from the belt cover layer.

3. The pneumatic tire for a passenger car according to claim 1, wherein the steel cord member has four or five strands, each formed by twisting four element wires together.

4. The pneumatic tire for a passenger car according to claim 1, wherein the diameter of the element wires is 0.08 to 0.15 mm.

5. The pneumatic tire for a passenger car according to claim 1, wherein the belt cover layer is formed by helically winding the single steel cord member in the tire circumference direction.

6. A method of manufacturing a pneumatic tire for a passenger car comprising:
producing a green tire by forming a belt cover layer by winding a steel cord member covered with unvulcanized rubber in a tire circumference direction on an outer peripheral side of a belt layer; and
vulcanizing the green tire while expanding a circumferential length of the green tire having the belt cover layer, and wherein
the steel cord member has a structure in which a plurality of element wires made of steel and having a diameter smaller than 0.18 mm are twisted together to form each of strands and the strands are twisted together in a same direction as a direction of twisting of the element wires, and
a twist pitch on each of the strands is smaller than a twist pitch on the steel cord member, the twist pitch on each of the strands is in a range of 1.0 mm to 2.0 mm, and the twist pitch on the steel cord member is in a range of 2.0 mm to 5.0 mm.

7. The method according to claim 6,
wherein the steel cord member after a vulcanization of green tire is covered with rubber and a void in the steel cord member is filled with the rubber; and
a ratio is 1.6 to 2.4, wherein the ratio is a ratio of tensile rigidity of the steel cord member taken out of the belt cover layer after the vulcanization to tensile rigidity of the steel cord member when a portion of the rubber covering the steel cord member and a portion of the rubber filling the void are removed from the belt cover layer.

8. The method according to claim 7, wherein a ratio H_{c}/H_{b} is 1.6 to 2.4, wherein the H_{c} is a tensile rigidity of the steel cord member after the vulcanization and the H_{b} is a tensile rigidity of the steel cord member before covered with the unvulcanized rubber.

9. The method according to claim 6, wherein the steel cord member has four or five strands, each formed by twisting four element wires together.

10. The method according to claim 6, wherein the diameter of the element wires is 0.08 to 0.15 mm.

11. The method according to claim 6, wherein the belt cover layer is formed by helically winding the single steel cord member in the tire circumference direction in forming the belt cover layer.

12. The pneumatic tire for a passenger car according to claim 2, wherein the steel cord member has four or five strands, each formed by twisting four element wires together.

13. The pneumatic tire for a passenger car according to claim 2, wherein the diameter of the element wires is 0.08 to 0.15 mm.

14. The pneumatic tire for a passenger car according to claim 2, wherein the belt cover layer is formed by helically winding the single steel cord member in the tire circumference direction.

15. The pneumatic tire for a passenger car according to claim 12, wherein
the diameter of the element wires is 0.08 to 0.15 mm; and
the belt cover layer is formed by helically winding the single steel cord member in the tire circumference direction.

16. The pneumatic tire for a passenger car according to claim 1, further comprising
a pair of sidewall portions; and
a tread portion disposed between the sidewall portions, the tread portion including a carcass layer,
wherein the belt layer is formed on an outer peripheral side of the carcass layer, and the belt cover layer is formed on an outer peripheral side of the belt layer.

17. The method according to claim 7, wherein the steel cord member has four or five strands, each formed by twisting four element wires together.

18. The method according to claim 7, wherein the diameter of the element wires is 0.08 to 0.15 mm.

19. The method according to claim 8, wherein
the steel cord member has four or five strands, each formed by twisting four element wires together;
the diameter of the element wires is 0.08 to 0.15 mm; and
the belt cover layer is formed by helically winding the single steel cord member in the tire circumference direction in forming the belt cover layer.

20. The method according to claim 6, wherein
the producing the green tire further includes forming a pair of sidewall portions, and forming a tread portion between the sidewall portions, the tread portion including a carcass layer and the belt layer being formed on an outer peripheral side of the carcass layer.
